(19) United States
(12) Patent Application Publication
(10) Pub. No.: US 2026/0339065 A1
(43) Pub. Date: Oct. 29, 2026

(54) BINOCULAR WITH BRIDGE LOCKING ASSEMBLY

(71) Applicant: BUSHNELL INC., Overland Park, KS (US)

(72) Inventors: Logan S. TUEL, Overland Park, KS (US); Michael A. SIZEMORE, Overland Park, KS (US); Travis C. OVERFELT, Overland Park, KS (US); Gregory L. PALKOWITSH, Overland Park, KS (US); Xiangyong YANG, Yunnan (CN)

(21) Appl. No.: 19/102,494

(22) PCT Filed: Aug. 10, 2023
(86) PCT No.: PCT/CN2023/112207

§ 371 Date: Feb. 10, 2025

(30) Foreign Application Priority Data
Aug. 10, 2022 (WO) PCT/CN2022/111453

(51) Int. Cl. G02B 7/12; G02B 23/18

(52) U.S. Cl. CPC G02B 7/12; G02B 23/18

(57) ABSTRACT

A pair of binoculars having a first barrel comprising an eyepiece optic, an objective optic and a first bridge portion, a second barrel comprising an eyepiece optic, an objective optic and a second bridge portion, angularly pivotable for adjusting an interpupillary distance between two eyepiece optics; and a locking assembly comprising; a pivoting member fixed to the first bridge portion; a bushing fixed to the second bridge portion and defining a first engagement surface; and a locking member restricting relative angular movement between the locking member, the pivoting member and the first bridge portion, the locking member defining a second engagement surface and longitudinally movable along the third longitudinal axis between at least a first position spaced apart from the first engagement surface and a second position engaged with the first engagement surface, such that when the first engagement surface and the second engagement surface are engaged, the first bridge portion is immobile relative to the second bridge portion.

### FIELD

The field of the present disclosure relates to binoculars and particularly to binoculars having a pair of barrels having an adjustable interpupillary distance (IPD), and a locking mechanism for same.

### BACKGROUND

For binoculars having a pair of barrels, each including an eyepiece, it is desirable to alter the spacing of the eyepieces in order to approximate the IPD of the user. In order to achieve such adjustment of the IPD, the first and second barrels include one or more bridge portions that are pivotably mounted.

While the adjustment of the IPD is useful, it is desirable to maintain the IPD spacing afterwards during use of the binoculars.

### SUMMARY

In one aspect, a pair of binoculars is provided, including a first barrel having a first eyepiece optic, a first objective optic and a first bridge portion, the first barrel defining a first longitudinal axis extending from the first eyepiece optic to the first objective optic; a second barrel having a second eyepiece optic, a second objective optic and a second bridge portion, the second barrel defining a second longitudinal axis substantially parallel to the first longitudinal axis extending from the second eyepiece optic to the second objective optic; wherein the first bridge portion and the second bridge portion are angularly pivotable about a third longitudinal axis substantially parallel to the first and second longitudinal axis and capable to adjusting an interpupillary distance (IPD) between the first eyepiece optic and the second eyepiece optic; and a locking assembly including a pivoting member fixed to the first bridge portion; a bushing fixed to the second bridge portion and defining a first engagement surface; and a locking member restricting relative angular movement between the locking member, the pivoting member and the first bridge portion, the locking member defining a second engagement surface and longitudinally movable along the third longitudinal axis between at least a first position spaced apart from the first engagement surface and a second position engaged with the first engagement surface, such that when the first engagement surface and the second engagement surface are engaged, the first bridge portion is immobile relative to the second bridge portion.

In some embodiments, the first engagement surface comprises gear teeth, and the second engagement surface comprises gear teeth. In some embodiments, the first engagement surface and the second engagement surface comprise mating tapered surfaces.

In some embodiments, the pivoting member defines a longitudinal bore therethrough, and the locking member comprises a longitudinal member longitudinally slidable within the longitudinal bore. In some embodiments, the longitudinal bore of the pivoting member defines a shoulder portion engageable with a head portion of the longitudinal member to restrict the longitudinal movement of the longitudinal member with respect to the pivoting member, In some embodiments, the locking member further comprises a disc coupled to the longitudinal member and defining a projection having a pair of surfaces.

In some embodiments, the pivoting member is a split screw comprising a first member and a second member spaced apart from the first member, and wherein the pair of surfaces of the projection cooperate with the first and second members to restrict relative angular movement between the locking member, the pivoting member and the first bridge portion.

In some embodiments, the locking member comprising an annular ring, and wherein the second engagement surface comprises gear teeth on the ring, and the first engagement surface comprises gear teeth on the bushing.

In some embodiments, the bushing supports an O-ring thereon, and the annular ring defines a first and a second annular recess for cooperating with the O-ring when the locking member is in the first and second positions. In some embodiments, the annular ring comprises external textured surface.

In another aspect, a pair of binoculars is provided having a first barrel comprising a first eyepiece optic, a first objective optic and a first contact surface, the first barrel defining a first longitudinal axis extending from the first eyepiece optic to the first objective optic; a second barrel comprising a second eyepiece optic, a second objective optic and a second contact surface, the second barrel defining a second longitudinal axis substantially parallel to the first longitudinal axis extending from the second eyepiece optic to the second objective optic; wherein the first bridge portion and the second bridge portion are angularly pivotable about a third longitudinal axis substantially parallel to the first and second longitudinal axis and capable to adjusting an IPD) between the first eyepiece optic and the second eyepiece optic; and a locking assembly including an adjustable member defining a surface movable between a first position spaced apart from the first contact surface and the second contact surface, and a second position engaged with the first contact surface and the second contact surface to prevent relative pivotable movement of the first barrel with respect to the second barrel.

In some embodiments, the adjustable member is a flexible sleeve, and the locking assembly includes a first disc and second disc, wherein, when the first disc and second disc are approximated the flexible sleeve expands to the second position to contact the first and second contact surfaces, and when the first and second disc are spaced apart, the flexible sleeve is in a relaxed configuration spaced apart from the first and second contact surfaces In some embodiments, the adjustable member includes a push button having a pair of first splines, and the first and second contact surfaces include second splines disposed on the first barrel and the second barrel, wherein the first configuration comprises the first splines on the push button and the second splines on the first and second barrel are spaced apart, and the second configuration comprises the first splines on the push button and the second splines on the first and second barrel are approximated.

In some embodiments, the adjustable member includes a longitudinally movable wedge member, and the first and second contact surfaces comprise angled side walls disposed on the first barrel and the second barrel, wherein the first configuration comprises the wedge member longitudinally spaced apart from the angled side walls, and the second configuration comprises the wedge member longitudinally positioned to engage the angled side walls.

In some embodiments, the adjustable member includes an angular rotatable member having a pivotable lever defining a cam surface, wherein when the pivotable lever is in a first position, the cam surface is spaced apart from the first and second engagement surfaces, and then the lever is in the second position, the cam surface is engaged with first and second contact surfaces.

In some embodiments, the adjustable member includes a stem fixed to one of the first and second bridge portions, the stem defining a helical cam surface; a body defining a body contact surface and a angularly disposed slot; and a lever and sleeve angularly disposed about the stem and within the angular disposed body, such that lever moves longitudinally with the body, and an end portion of the lever disposed within the helical cam, such that when the lever is angularly rotated with respect to the stem, the lever is disposed longitudinally, the first configuration comprising when the body contact surface is spaced apparat from the first and second contact surfaces and the second configuration comprising the body contact surface spaced apart from the first and second contact surfaces.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1 is an isometric view of a pair of binoculars in accordance with an exemplary embodiment of the disclosed subject matter.

FIG. 2 is an eyepiece end view of the binoculars of FIG. 1 in a first configuration showing a first inter-pupillary distance.

FIG. 3 is an eyepiece end view of the binoculars of FIG. 1 in a second configuration showing a second inter-pupillary distance.

FIG. 4 is an isometric view with parts separated of the binoculars of FIG. 1.

FIG. 5 is an isometric view with parts separated of the binoculars of FIG. 1 from the eyepiece side

FIG. 6 is an isometric view with parts separated of the binoculars of FIG. 1 from the objective side.

FIG. 7 is an isometric view with parts separated of the binoculars of FIG. 1 from the objective side.

FIG. 8A is an isometric view with parts separated of the binoculars of FIG. 1 from the eyepiece side.

FIG. 8B is an isometric view with parts separated of the binoculars of FIG. 1 from the objective side.

FIG. 9 is a longitudinal cross-sectional view of the binoculars of FIG. 1 taken from line 9-9 with the locking assembly in a locked configuration.

FIG. 10 is a longitudinal cross-sectional view of the binoculars of FIG. 1 taken from line 9-9 with the locking assembly in an unlocked configuration.

FIG. 11 is an isometric view of a component of the binoculars of FIG. 1.

FIG. 12 is an isometric view of a component of the binoculars of FIG. 1.

FIG. 13 is a longitudinal cross-sectional view of a component of the binoculars of FIG. 1.

FIG. 14 is a longitudinal cross-sectional view of a components of the binoculars of FIG. 1.

FIG. 15 is a simplified eyepiece-end view of binoculars in accordance with another exemplary embodiment of the disclosed subject matter.

FIG. 16 is a simplified top view of binoculars in accordance with another exemplary embodiment of the disclosed subject matter.

FIG. 17 is an isometric view of binoculars in accordance with another exemplary embodiment of the disclosed subject matter.

FIG. 18 is an enlarged view of the components of the binoculars illustrated in FIG. 17 in a locked configuration.

FIG. 19 is an enlarged view of the components of the binoculars illustrated in FIG. 17 in an unlocked configuration.

FIG. 20 is an isometric view of binoculars in accordance with another exemplary embodiment of the disclosed subject matter.

FIG. 21 is an enlarged view of the components of the binoculars illustrated in FIG. 20 in a locked configuration.

FIG. 22 is a longitudinal cross-sectional view of a components of the binoculars of FIG. 20.

FIG. 23 is an enlarged isometric view of the components of the binoculars of FIG. 20.

FIG. 24 is a longitudinal cross-sectional view of a component of the binoculars of FIG. 20.

FIG. 25 is an isometric view of binoculars in accordance with another exemplary embodiment of the disclosed subject matter.

FIG. 26 is a longitudinal view in partial cross section of the binoculars of FIG. 25 in a locked configuration.

FIG. 27 is a longitudinal view in partial cross section of the binoculars of FIG. 25 in an unlocked configuration.

FIG. 28 is an isometric view of binoculars in accordance with another exemplary embodiment of the disclosed subject matter.

FIG. 29 is a longitudinal cross-sectional view of the binoculars of FIG. 28 in a locked position.

FIG. 30 is a longitudinal cross-sectional view of the binoculars of FIG. 28 in an unlocked position.

FIG. 31 is an isometric view of a pair of binoculars in accordance with another exemplary embodiment of the disclosed subject matter.

FIG. 32 is an isometric view with parts separated of the binoculars of FIG. 31 from the eyepiece side

FIG. 33 is an isometric view with parts separated of the binoculars of FIG. 31 from the objective side.

FIG. 34 is an isometric view with parts separated of the binoculars of FIG. 31 from the eyepiece side.

FIG. 35 is a side view of selected components of the binoculars of FIG. 31.

FIG. 36 is an isometric view of selected components of the binoculars of FIG. 31 from the objective side.

FIG. 37 is an objective end view of selected components of the binoculars of FIG. 31 from the objective side.

FIG. 38 is an enlarged isometric view of a component of the binoculars of FIG. 31.

FIG. 39 is an enlarged isometric view of a component of the binoculars of FIG. 31 from the eyepiece side.

FIG. 40 is an enlarged isometric view of the component of FIG. 39 from the eyepiece side.

### DETAILED DESCRIPTION OF EXEMPLARY EMBODIMENTS

Various aspects of the apparatuses and methods disclosed herein are described more fully hereinafter with reference to the accompanying drawings. This disclosure may, however, be embodied in many different forms and should not be construed as limited to any specific structure or function presented throughout this disclosure.

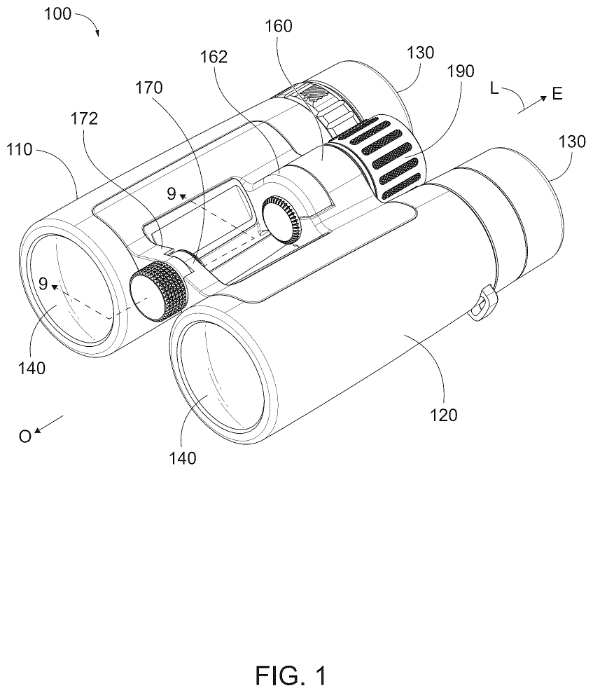

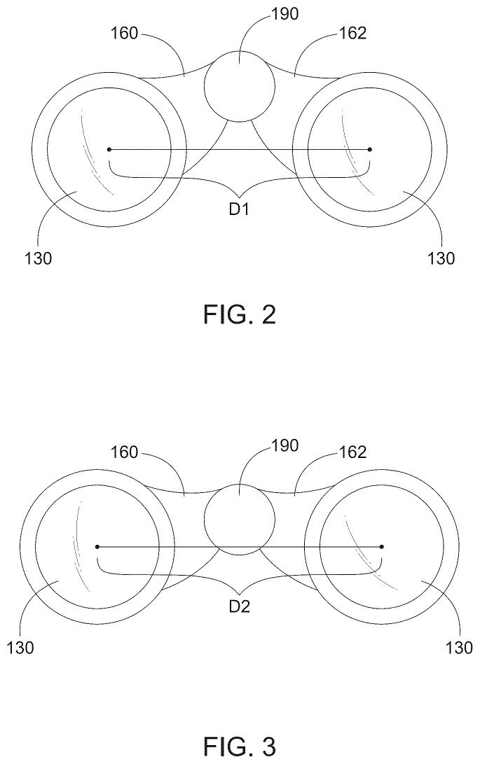

As illustrated in FIG. 1, the binoculars 100 includes a right barrel 110 and left barrel 120, a set of eyepiece lenses 130, objective lenses 140, and a focusing knob 190. The longitudinal axis L extends from the eyepiece end E to the objective end O. It is desirable for the use of the binoculars to be able to adjust the interpupillary distance (IPD) between the eyepiece lenses 130 to match the IPD of the user. In order to do so, the binoculars 100 are provided with a set of pivotable bridge components 160/162 and 170/172 that allow the user to adjust the spacing of the left barrel 120 and right barrel 110. As shown in FIG. 2, the rear bridge components 160 and 162 and front bridge components 170 and 172 (not shown in FIG. 2) are arranged to provide a first IPD D1. In FIG. 3, the rear bridge components 160 and 162 and front bridge components 170 and 172 (not shown in FIG. 3) are arranged to provide a second IPD D2. Thea right barrel 110 defines a first longitudinal axis extending from the first eyepiece optic 130 to the first objective optic 140. The left barrel 120 defines a second longitudinal axis substantially parallel to the first longitudinal axis extending from the second eyepiece optic 130 to the second objective optic 140. The bridge portion 160/162 and 170/172 are angularly pivotable about a third longitudinal axis substantially parallel to the first and second longitudinal axis and capable to adjusting the IPD between the first eyepiece optic and the second eyepiece optic.

In accordance with the disclosed subject matter, binoculars 100 are provided with an IPD locking assembly. The IPD locking assembly maintains the relative positions of the right barrel 110 and the left barrel 120 at the desired IPD. Moreover, when there is a need to adjust the binoculars 100 to a new IPD, the locking assembly allows the right barrel 110 and the left barrel 120 to pivot relative to each other to a new IPD.

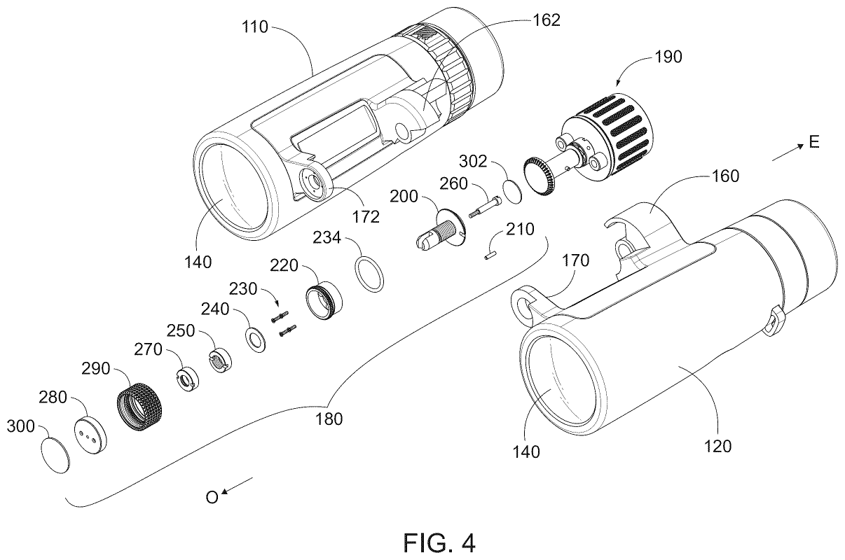

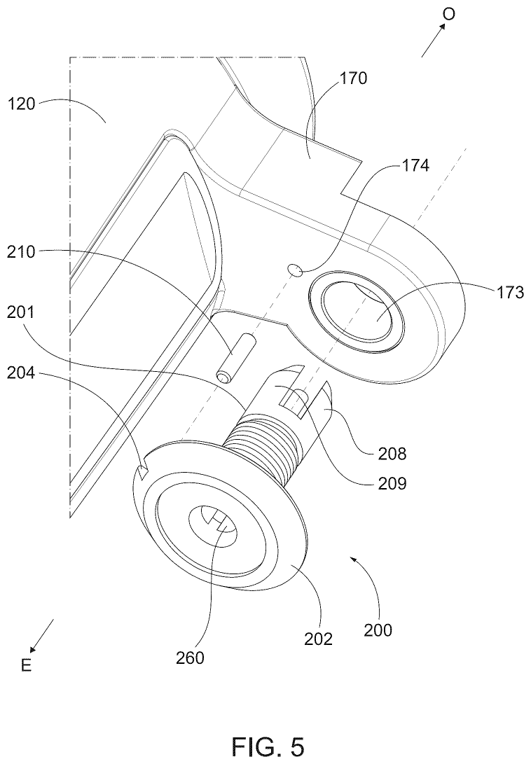

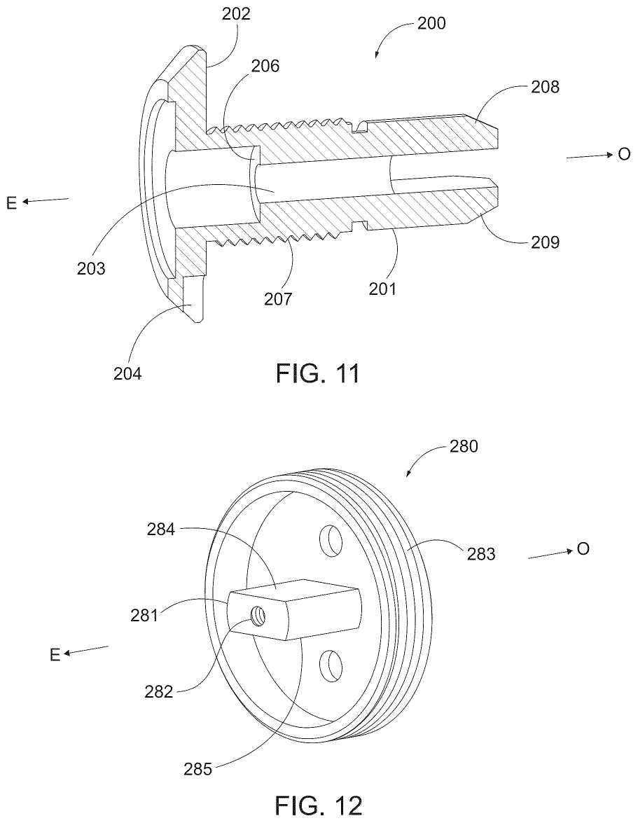

FIG. 4 illustrates the components of the binoculars 100 with parts separated. FIGS. 5-7 illustrate certain subassemblies of the IPD locking apparatus. As illustrated in FIG. 5, a pivoting member, e.g., split screw 200, is coupled to the left front bridge 170 of the left barrel 120. FIG. 11 illustrates the split screw 200 in greater detail. Split screw 200 includes a main shaft component 201 having a central bore 203 extending therethrough and a flange 202. The shaft portion 201 extends through the aperture 173 in left front bridge 170. The flange 202 contacts the left front bridge 170 and stabilizes the split screw 200 with respect to the front bridge 170. A dowel 210 passes through a recess 204 in the flange 202 of the split screw 200 and through an aperture 174 in the left front bridge 170 to prevent rotation of the split screw 200 within the aperture 173 of the left front bridge 170.

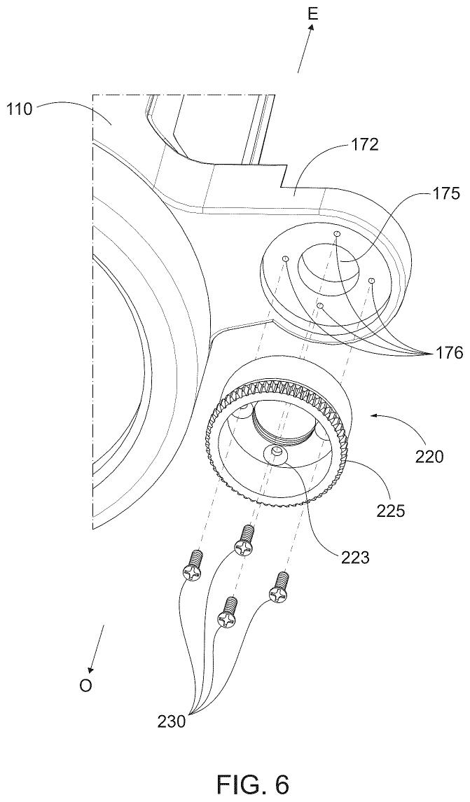

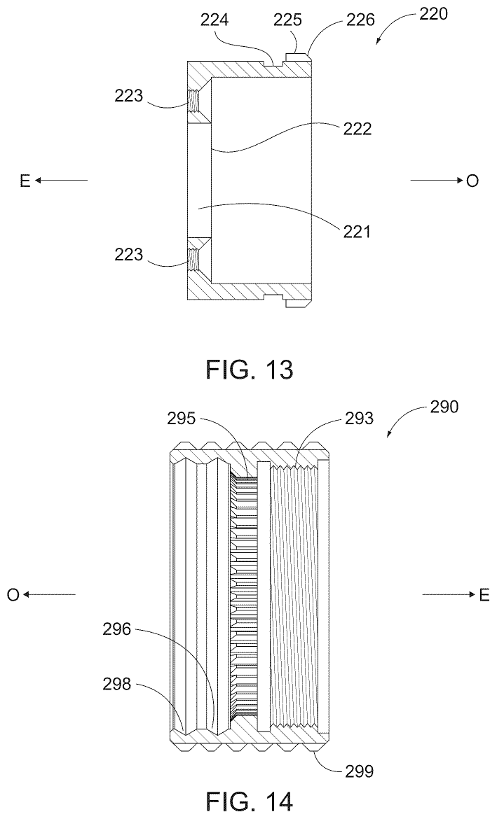

As illustrated in FIG. 6, a bushing 220 is coupled to the right front bridge 172 of the right barrel 110. FIG. 13 illustrates the bushing 13 in greater detail. The bushing 220 is arranged such that the bore 221 of the bushing 220 is aligned with the aperture 175 in the right front bridge 172. One or more screws 230 secure the bushing 220 to the right front bridge 172 by passing through holes 223 in bushing 220 and into threaded holes 176 in right front bridge 172. It is understood that bushing 220 can be secured to right front bridge 172 by other means known in the art, such as adhesives.

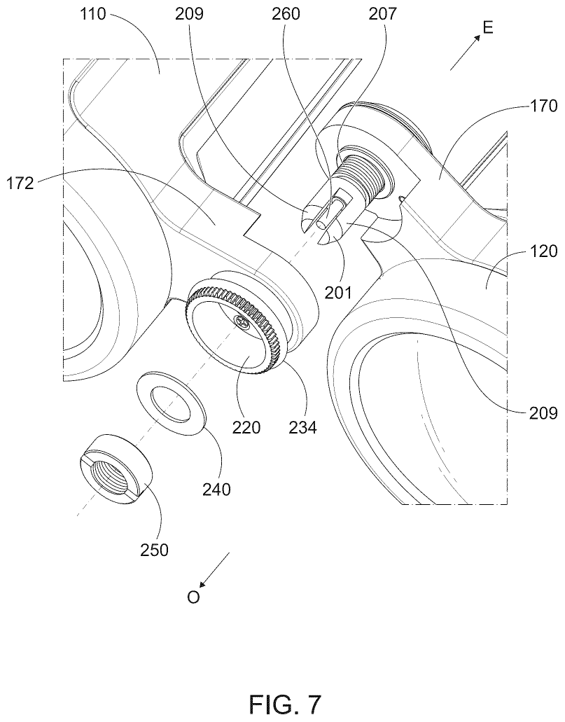

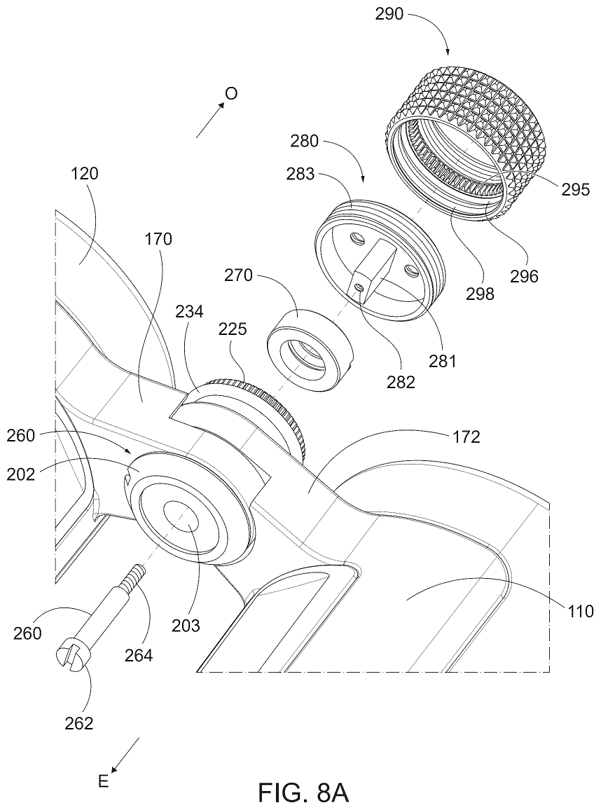

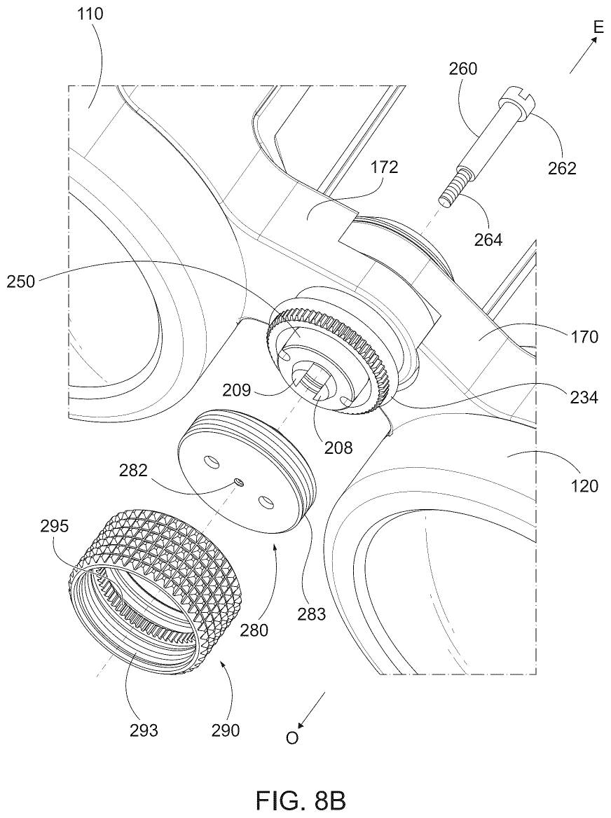

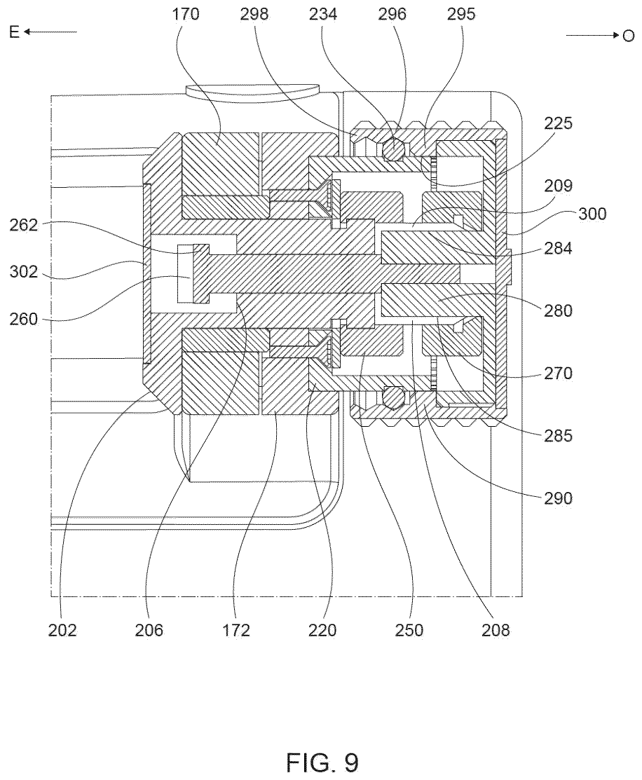

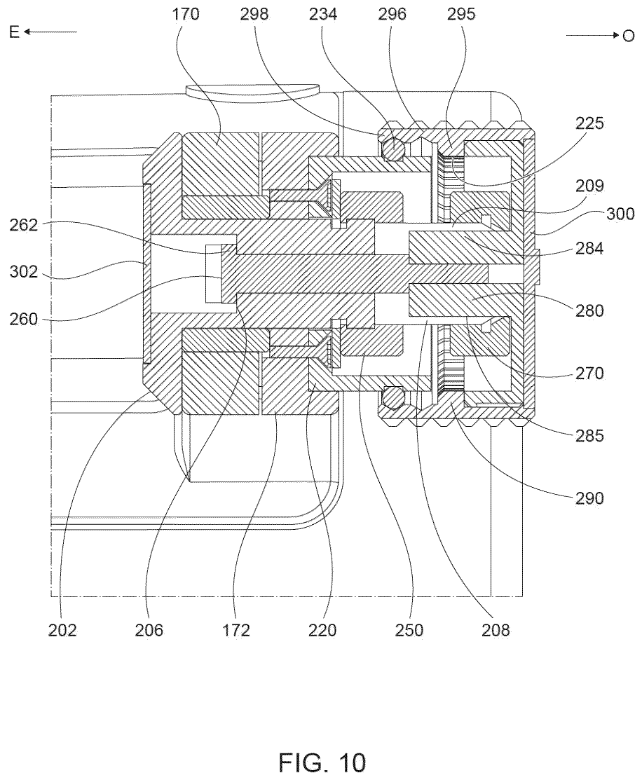

FIG. 7 illustrates an approximation of the assemblies shown in FIGS. 5 and 6. In particular, the shaft portion 201 of split screw 200 passes through the apertures 174 of right front bridge 172 and the bore 221. A washer 220 is placed over the shaft 201 of split screw 200 and on the face 222 of the bushing 200. A lock nut 250 is disposed over the washer 240 and the shaft 201. The lock nut 250, having an internal threading, is tightened over the threading 207 of the split screw 200. Upon securing over the lock nut 250 to the split screw 200, the left barrel 120 and right barrel 110 are capable of freely pivoting about split screw 200 to adjust the IPD of the eyepieces 130 FIGS. 8A-8B illustrate a further step in the assembly of the apparatus. Longitudinal member, e.g., slider screw 260, is slidably inserted within the bore 203 of the pivoting member, e.g., split screw 200. The limit of travel of the slider screw 260 is established by the contact of the head 262 thereof with a shoulder 206 defined within the bore 203 of the split screw 200. (See also FIGS. 9-10 discussed in greater detail herein.) A disc 280 is threadingly coupled to a locking knob 290 via external threads 283 on the disc 280 and internal threads 293 on the knob 290. FIGS. 12 and 14 illustrate the features of the disc 280 and knob 290, respectively, in greater detail. Locking knob 290 is an annular ring with additional features and external textured surface to assist the user is adjusting the locking mechanism. The threaded end portion 264 of the slider screw 260 is received within the threaded bore 282 of the disc 280. When the slider screw 260 is coupled to the disc 280, the slider screw 260, the disc 280 and the knob 290 are capable of sliding longitudinally together. A taper nut 270 is provided over the slider screw 260 and the split screw 200, and provides additional stability to the mechanism. The disc 280 includes a protrusion 281 having a first protrusion face 284 and a second protrusion face 285. (See FIG. 12). The split screw 202 includes first member 208 and a second member 209. (See FIG. 11). The first member 208 and second member 209 are sized and configured to cooperate with the first protrusion face 284 and second protrusion face 285, such that the first member 208 is slidable over the first protrusion face 284 and the second member 209 is slidable over the second protrusion face 285. This arrangement allows the disc 280, knob 290 and slider screw 260 move longitudinally relative to the slider screw 200, but to inhibit rotational movement of the disc 280, knob 290 and slider screw 260 relative to the split screw 200.

FIG. 9 illustrates the binoculars 100 in a locked configuration. When locked, the left front bridge 170 and right front bridge 172 are immovable relative to each other, thereby locking the left barrel 120 and right barrel 110, and also the eyepieces 130 to a fixed IPD. In the locked configuration, the locking knob 290, disc 280 and slider screw 260 are shifted to the position closest to the eyepiece. The knob 190 includes an engagement surface, e.g., internal gear teeth 295, which cooperate with an engagement surface, e.g., external gear teeth 225, on the bushing 220. (See also FIGS. 13-14). As discussed above, the bushing 220 is coupled to the right barrel 110 via the right front bridge 170. The knob 290 is coupled to the left barrel 120 via the interaction of the disc protrusion 281 with the split screw 200. Thus, when the gear teeth 225 of the bushing 220 is coupled with the gear teeth 295 of the knob 290, the left barrel 120 and right barrel 110 are locked. When the knob 290 is in the locked position, the head 262 of the slider screw 260 is spaced apart from the shoulder 206 of the bore 203 of the split screw 200.

The knob 290 interacts with an O-ring 234 provided on the bushing 220 to reduce unintended movement of the knob 290. The O-ring 234 is fitted over an external annular recess 224 in the bushing. (See FIG. 13.) The knob 290 is provided with two internal annular recesses, first annular recess 296 and second annular recess 298, that cooperate with the O-ring 234. (See FIG. 14.) When the knob 290 is in the locked configuration, the O-ring 234 is received in the first annular recess 296. (See FIG. 9), that provides resistance to accidental relative movement of the knob 290, but which resistance can be overcome by the user.

FIG. 10 illustrates the binoculars 100 in an unlocked configuration. When unlocked, the left front bridge 170 and right front bridge are pivotable relative to each other, thereby allowing the left barrel 120 and right barrel 110 and the eyepieces 130 to adjust the IPD. In the unlocked configuration, the locking knob 290, the disc 280 and slider screw 260 are shifted to a position furthest from the eyepiece. The internal gear teeth 295 of the knob 290 thus spaced apart from the external gear teeth 225 on the bushing 220. When the gear teeth 225 of the bushing 220 are spaced apart from the gear teeth 295 of the knob, the left barrel 120 and right barrel 110 are freely pivotable. When the knob 290 is in the unlocked configuration, the O-ring 234 is removed from the first annular recess 296, and received in the second annular recess 298. (See FIG. 10).

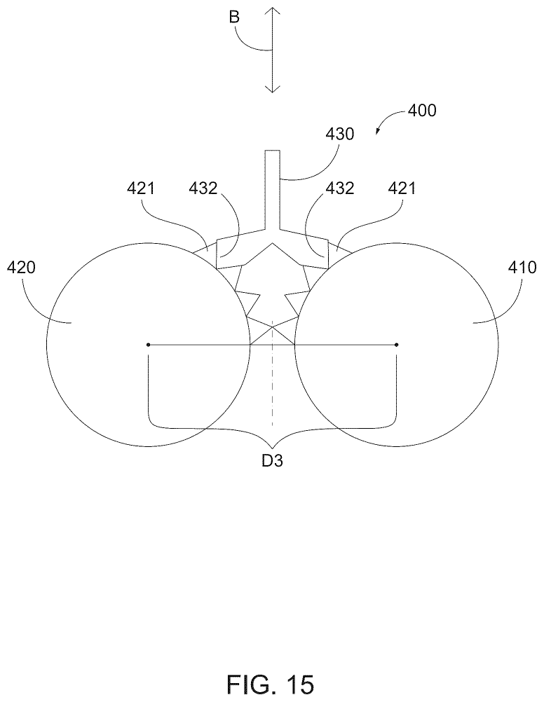

An exemplary embodiment of binoculars 400 is illustrated in FIG. 15. Binoculars 400 are substantially the same as binoculars 100 described above, with the differences noted herein. Binoculars 400 includes a pair of bridge components (not shown) capable of adjusting the IPD distance D3 between the left barrel 420 and right barrel 410. (See FIGS. 2-3.) Binocular 400 include an adjustable member, e.g., push button 430. A first contact surface, e.g., an external spline-like feature 420 is formed on barrel 410 and a second contact surface, e.g., an external spline-like feature 420 is formed on barrel 420 that fix the barrels 410/420 together when the push button 430 with a mating external spline 432 is fully depressed in direction B into both binocular barrel splines 420. In some embodiments, the button 430 is mounted on a housing allowing button 430 to move toward and away from the splines 432. This will lock the two barrels 410/420 together. FIG. 15 illustrates the binoculars 400 in the locked position. In some embodiments, a biasing member, such as spring, is provided to bias the push button 430 in the position engaged with the splines 432.

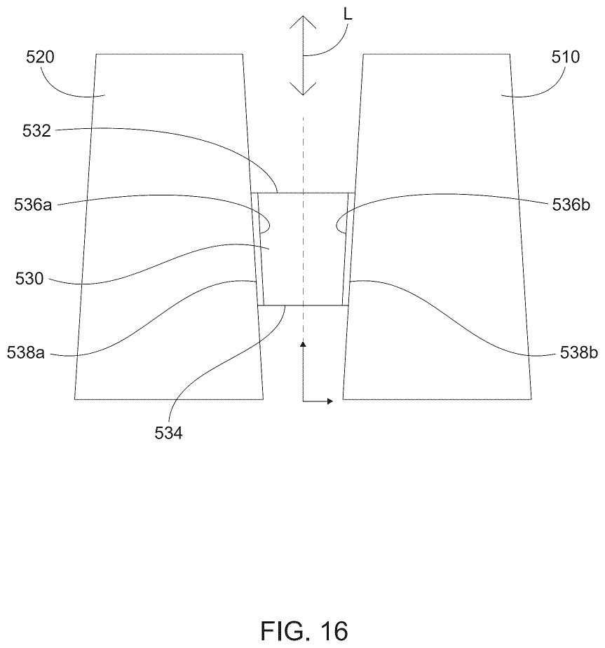

An exemplary embodiment of binoculars 500 is illustrated in FIG. 16. Binoculars 500 are substantially the same as binoculars 100 described above, with the differences noted herein. Binoculars 500 includes a pair of bridge components (not shown) capable of adjusting the IPD distance between the left barrel 520 and right barrel 510. Binoculars 500 incorporates an adjustable member, e.g., a wedge member 530 that translates axially (arrow L) between the two binocular barrels 510/520. Wedge member includes a first portion 532 having a first dimension and a second portion 534 having a second dimension, with the first dimension greater than the second dimension. The wedge member 530 further includes a pair of engaging surfaces 536a/b configured to slidably engage a pair of contact surfaces 538a/b on the barrels 510/520, respectively. In use, user can adjust the binoculars to the desired IPD (see, e.g., FIGS. 2-3), and then slide the wedge member 530 axially until the surfaces 536a/b are engaged with the corresponding surfaces 538a/b on the barrels 510/520. When surfaces 536a/b are engaged with the surfaces 538a/b, the barrels 510/520 will be stopped at the desired IPD when the user rotates the barrels inward.

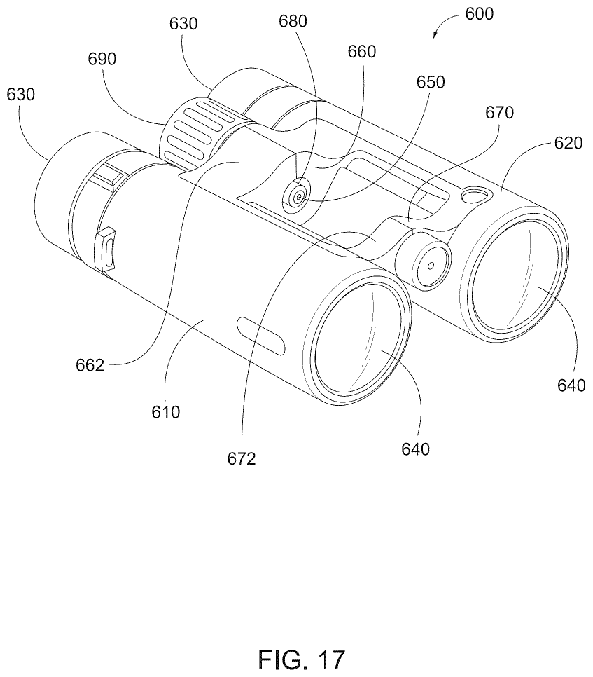

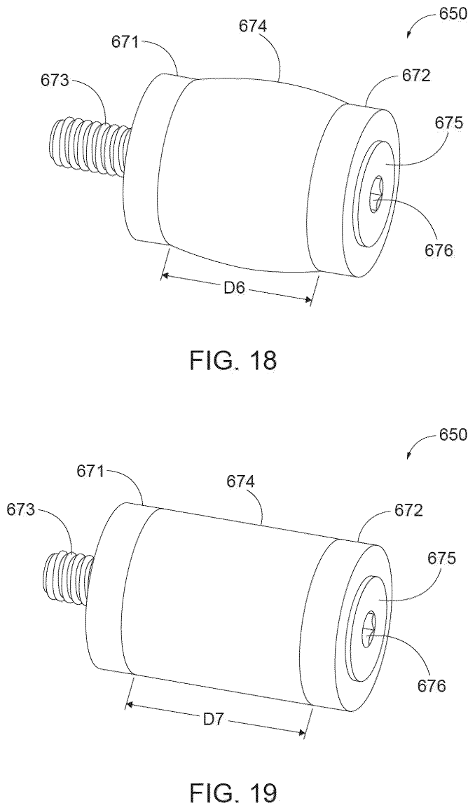

An exemplary embodiment of binoculars 600 is illustrated in FIGS. 17-19. Binoculars 600 are substantially the same as binoculars 100 described above, with the differences noted herein. Binoculars 600 includes a right barrel 610 and left barrel 620, a set of eyepiece lenses 630, objective lenses 640, and a focusing knob 690. In order to adjust the IPD between the eyepiece lenses 630 to match the IPD of the user, the binoculars 600 are provided with a set of bridge components 660/662 and 670/672 that allow the user to adjust the spacing of the left barrel 620 and right barrel 610. In accordance with the disclosed subject matter, binoculars 600 are provided with an IPD locking assembly 650. As illustrated in FIG. 17, the IPD locking assembly 650 is received with a bore 680 formed with bridge portion 660/620. A portion of the wall of the bore 680 includes bridge 660 defining a first contact surface, and a portion of the wall of the bore 680 includes bridge 662 defining a second contact. IPD locking assembly 650 includes a first disc 671 and second disc 672 positioned over a screw 673 having a screw head 675. First disc 671 includes a threaded bore that threaded over the threads of screw 673. An adjustable member, e.g., a flexible sleeve 674 is fitted over screw 673 and between discs 671 and 672. As illustrated in FIG. 19, a distance D7 is defined between discs 671 and 672, while sleeve 674 is in a first position. As the screw head 675 is rotated, disc 671 is retained against longitudinal movement within the bore 680. Consequently, the distance D7 (FIG. 19) between discs 671/672 is reduced to distance D6 (FIG. 18). As the distance between the discs 671/672 is reduced, the flexible sleeve 674 is compressed and expands to wider diameter and engages the first and second contact surfaces, e.g., walls of the bore 680, including bridge portions 660/662, to secure the relative barrel positions of barrels 610/620. FIGS. 18 and 19 illustrate a hexagonal bore that can be adjusted by an appropriate tool. In some embodiments, an adjustment knob is provided to allow for hand rotation of screw head 675 by a user.

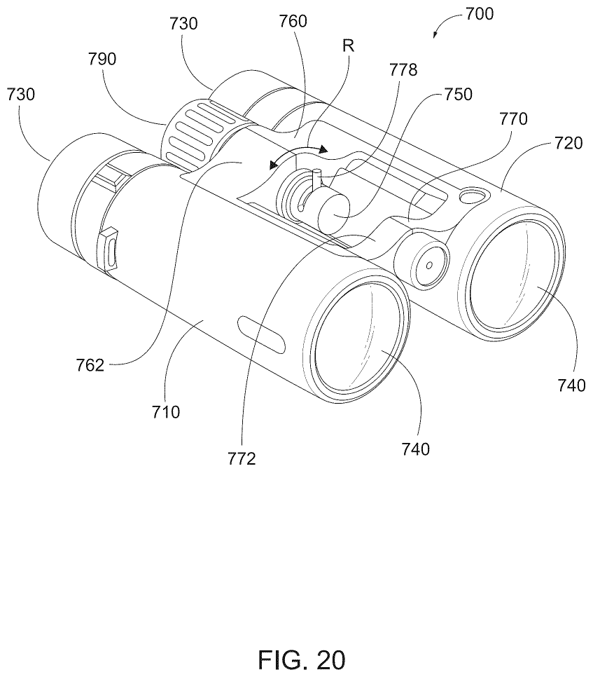

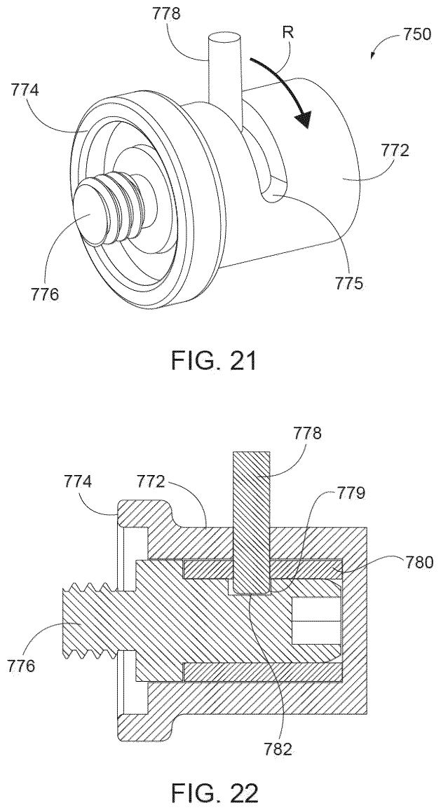

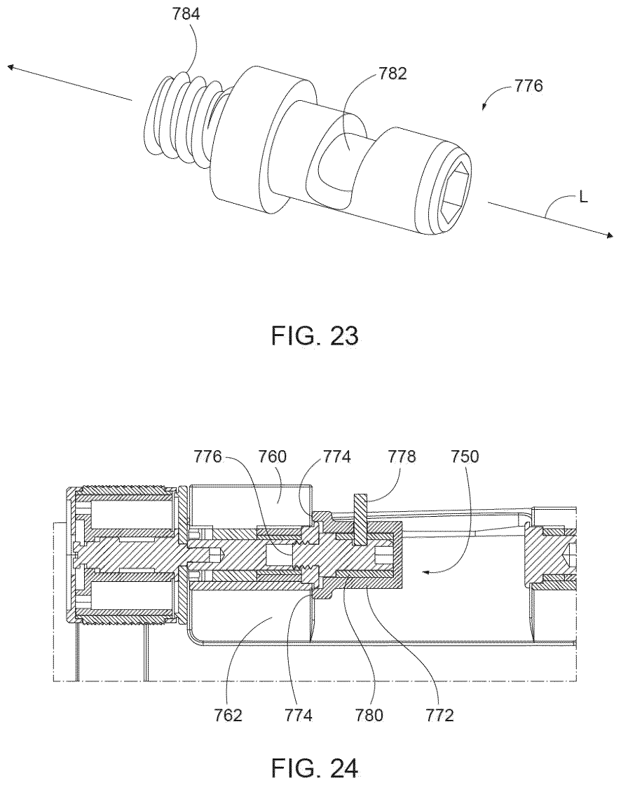

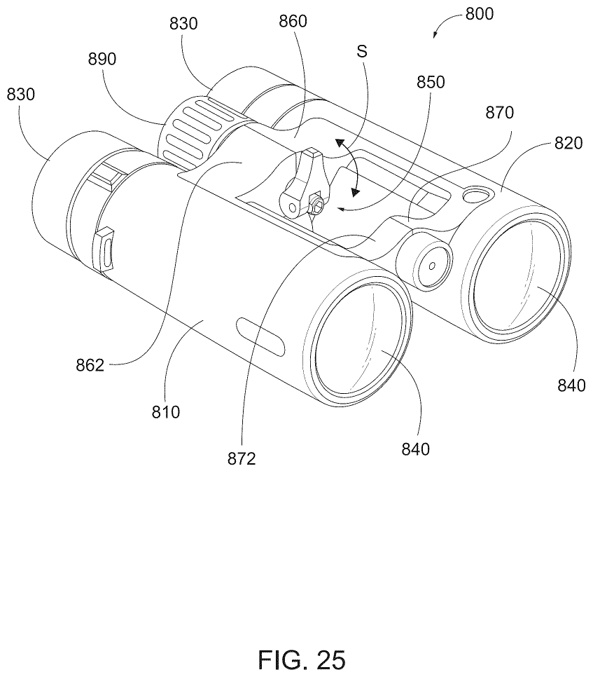

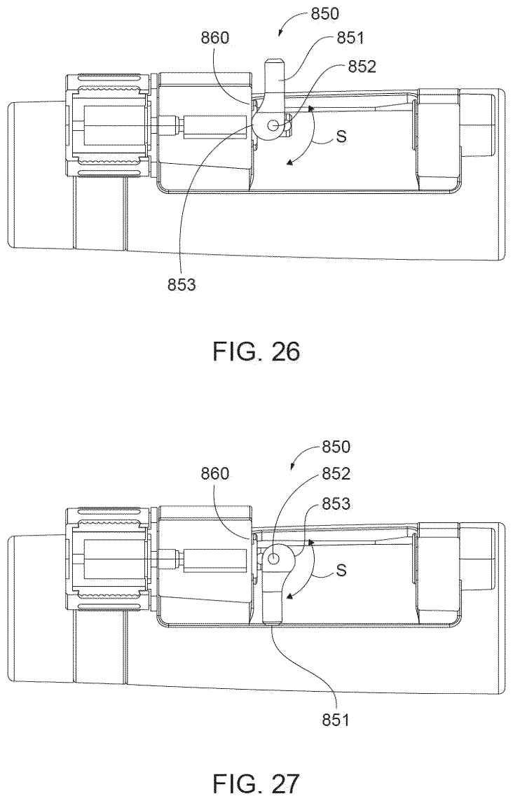

An exemplary embodiment of binoculars 700 is illustrated in FIGS. 20-24. Binoculars 700 are substantially the same as binoculars 100 described above, with the differences noted herein. Binoculars 700 includes a right barrel 710 and left barrel 720, a set of eyepiece lenses 730, objective lenses 740, and a focusing knob 790. In order to adjust the IPD between the eyepiece lenses 730 to match the IPD of the user, the binoculars 700 are provided with a set of bridge components 760/762 and 770/772 that allow the user to adjust the spacing of the left barrel 720 and right barrel 710. In accordance with the disclosed subject matter, binoculars 700 are provided with an IPD locking assembly 750. As illustrated in FIGS. 21-22, the IPD locking assembly 750 includes a stem 776, a body 772, a control sleeve 780 and a lever 778. When the lever 778 is rotated (see arrow R in FIG. 21), it forces the body 772 against the first and second contact surfaces of the bridge portions 760/762 to maintain the IPD in place. As shown in FIG. 22, lever 778 is coupled to control sleeve 780. Control sleeve 780 is fitted around stem 776. Lever 778 includes an end portion 779 that is positioned within a helical cam profile 782 of stem 776. As shown in FIG. 23, the cam profile 782 of stem 776 extends helically around the stem. Lever 778 is constrained to move in angular direction R within a channel 775 provided in body 772 (see FIG. 21). As the lever 778 is angularly rotated (direction R), the helical cam profile 782 carries the lever axially (direction L). Since the body 772 is constrained against moving axially relative to the lever 778 by the channel 775, the body 772 and lever 778 move axially together. When the body 772 moves axially towards the first and second contact surfaces of the bridge components 760/762, the surface 774 engages the components 760/762 to maintain the IPD in place. (FIG. 24.) An exemplary embodiment of binoculars 800 is illustrated in FIGS. 25-27. Binoculars 800 are substantially the same as binoculars 100 described above, with the differences noted herein. Binoculars 800 includes a right barrel 810 and left barrel 820, a set of eyepiece lenses 830, objective lenses 840, and a focusing knob 890. In order to adjust the IPD between the eyepiece lenses 830 to match the IPD of the user, the binoculars 800 are provided with a set of bridge components 860/862 and 870/872 that allow the user to adjust the spacing of the left barrel 820 and right barrel 810. In accordance with the disclosed subject matter, binoculars 800 are provided with an IPD locking assembly 850. As illustrated in FIGS. 26-27, the IPD locking assembly 850 includes an adjustable member, e.g., a lever 851, a pivot pin 852, and a cam profile 853. The lever 851 is pivotable about pin 852 in direction S (See FIGS. 26-27). When lever 851 is in the first position (see FIG. 27), the cam profile 853 is spaced apart from first and second contact surfaces of the bridge portions 860/862, allowing the barrels 810/812 to be freely pivotable to allow adjustment of IPD. When the lever 852 is rotated about the pin 852 to a second position (FIG. 26), the cam profile 853 is disposed against the contact surfaces of both bridge portions 860/862, thereby maintaining the IPD in place.

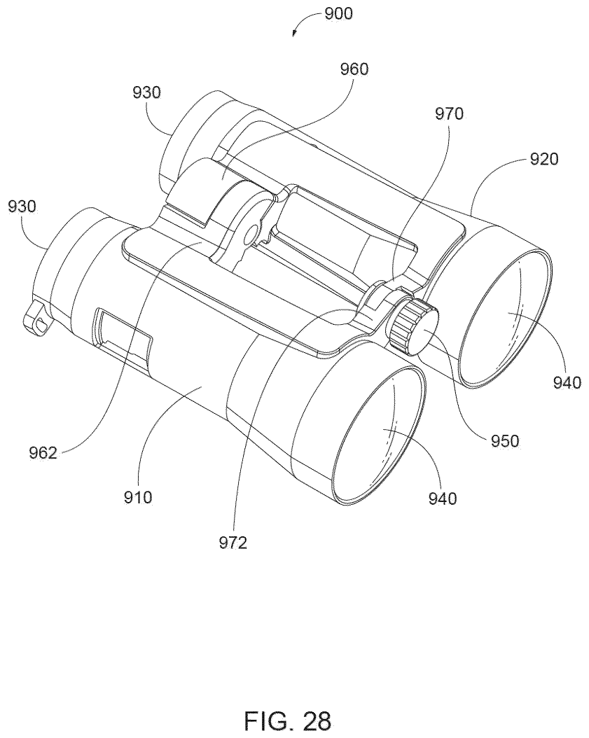

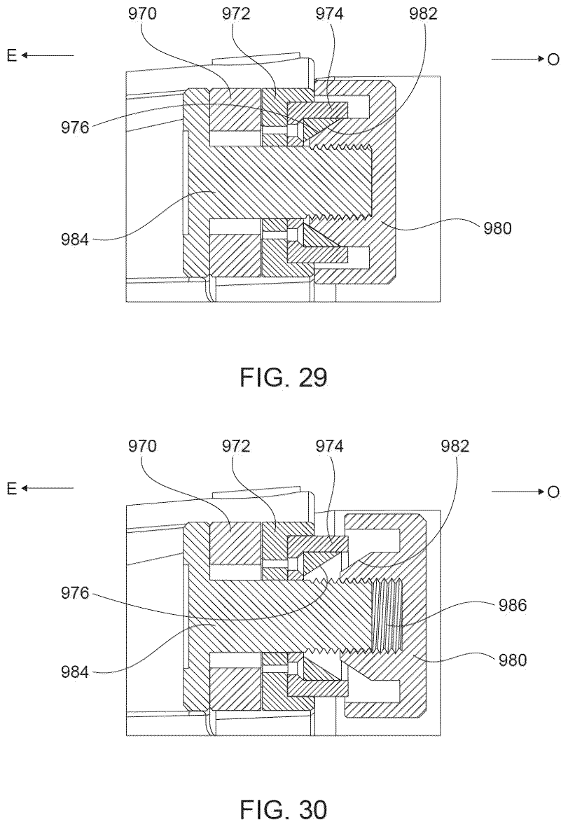

An exemplary embodiment of binoculars 900 is illustrated in FIGS. 28-30. Binoculars 900 are substantially the same as binoculars 100 described above, with the differences noted herein. Binoculars 900 includes a right barrel 910 and left barrel 920, a set of eyepiece lenses 930 and objective lenses 940. In order to adjust the IPD between the eyepiece lenses 930 to match the IPD of the user, the binoculars 900 are provided with a set of bridge components 960/962 and 970/972 that allow the user to adjust the spacing of the left barrel 920 and right barrel 910. In accordance with the disclosed subject matter, binoculars 900 are provided with an IPD locking assembly 950. As illustrated in FIGS. 29-30, the IPD locking assembly 950 includes a screw 984 fixed to left front bridge 970. A bushing 974 is fixed to right front bridge 972, e.g., with screws. Bushing 974 includes an internal taper 976. A locking knob 980 has an internal threading 986 and is threadedly movable with the threading on screw 984. Knob 980 further includes an external taper 982. FIG. 29 illustrates a locked configuration in which the internal taper 976 of bushing 972 is frictionally engaged with the external taper 982 of knob 980, thereby locking the left and right barrels 910/912. FIG. 30 illustrates an unlocked configuration in which the internal taper 976 of bushing 972 is spaced apart from the external taper 982 of knob 980, thereby allowing free movement between the left and right barrels 910/912.

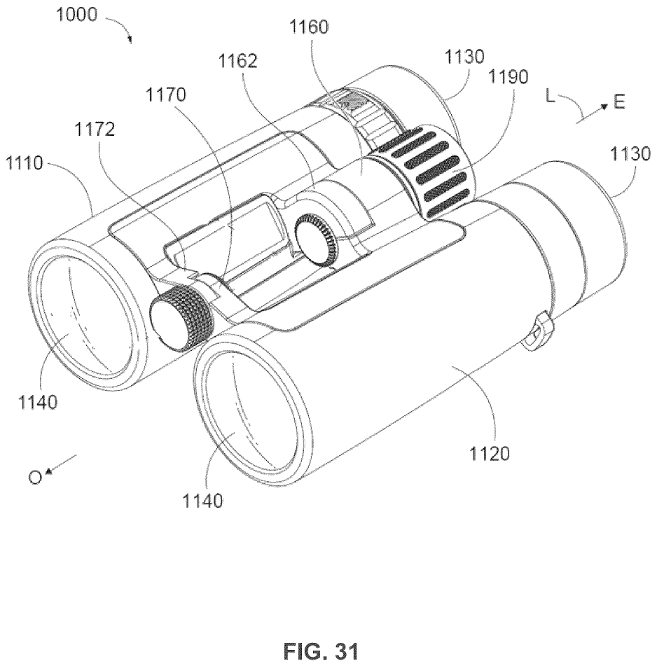

An exemplary embodiment of binoculars 1000 is illustrated in FIGS. 31-40. Binoculars 1000 is substantially identical to binoculars 100, with the substantial differences noted herein. Binoculars 1000 includes a right barrel 1110 and left barrel 1120, a set of eyepiece lenses 1130, objective lenses 1140, and a focusing knob 1190. The longitudinal axis L extends from the eyepiece end E to the objective end O. Binoculars 1000 are provided with a set of pivotable bridge components 1160/1162 and 1170/1172 that allow the user to adjust the spacing of the left barrel 1120 and right barrel 1110. The right barrel 1110 defines a first longitudinal axis extending from the first eyepiece optic 1130 to the first objective optic 1140. The left barrel 1120 defines a second longitudinal axis substantially parallel to the first longitudinal axis extending from the second eyepiece optic 1130 to the second objective optic 1140. The bridge portion 1160/1162 and 1170/1172 are angularly pivotable about a third longitudinal axis substantially parallel to the first and second longitudinal axis and capable to adjusting the IPD between the first eyepiece optic and the second eyepiece optic.

In accordance with the disclosed subject matter, binoculars 1000 are provided with an IPD locking assembly. The IPD locking assembly maintains the relative positions of the right barrel 1110 and the left barrel 1120 at the desired IPD. Moreover, when there is a need to adjust the binoculars 1000 to a new IPD, the locking assembly allows the right barrel 1110 and the left barrel 1120 to pivot relative to each other to a new IPD.

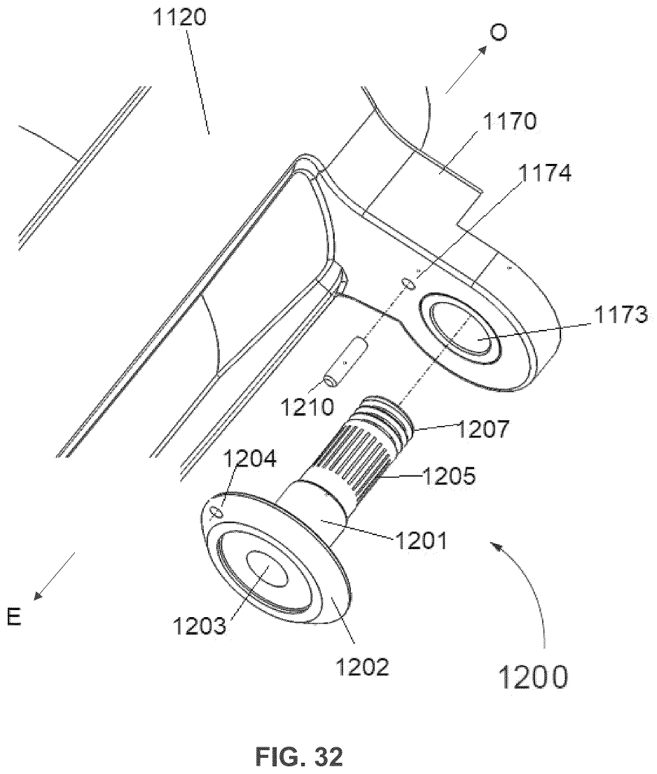

FIGS. 32-34 illustrates the components of the binoculars 1000 with parts separated. As illustrated in FIG. 32, a pivoting member, e.g., shaft member 1200, is coupled to the left front bridge 1170 of the left barrel 1120. Shaft member 1200 includes a main shaft component 1201 having a central bore 1203 extending therethrough and a flange 1202. Shaft component 1201 includes a roughened outer surface 1205 and a threaded end portion 1207. In some embodiments, the roughened outer surface 1205 is a series of raised ridges, surface detailing or scoring, or an applied gritty material. The shaft portion 1201 extends through the aperture 1173 in left front bridge 1170. The flange 1202 contacts the left front bridge 1170 and stabilizes the shaft member 1200 with respect to the front bridge 1170. A dowel 1210 passes through an aperture 1204 in the flange 1202 of the shaft member 1200 and through an aperture 1174 in the left front bridge 1170 to prevent rotation of the shaft member 1200 within the aperture 1173 of the left front bridge 1170.

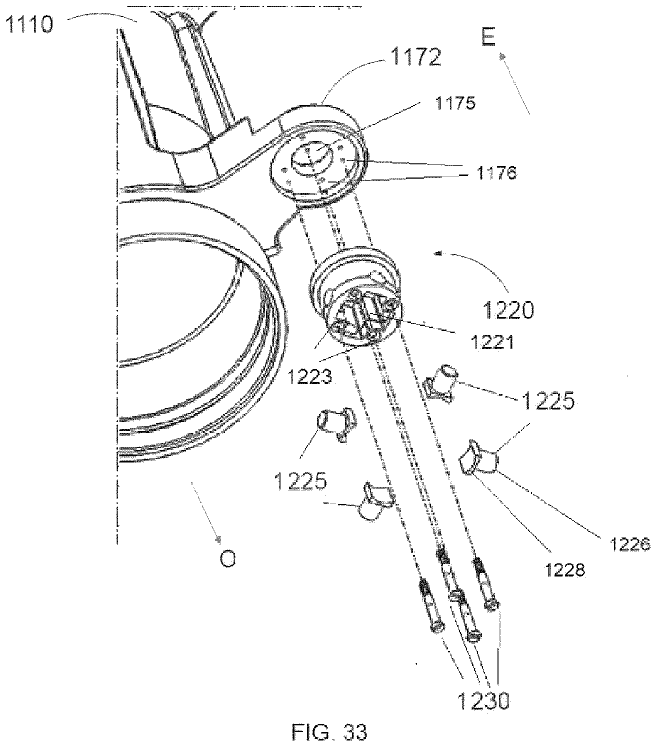

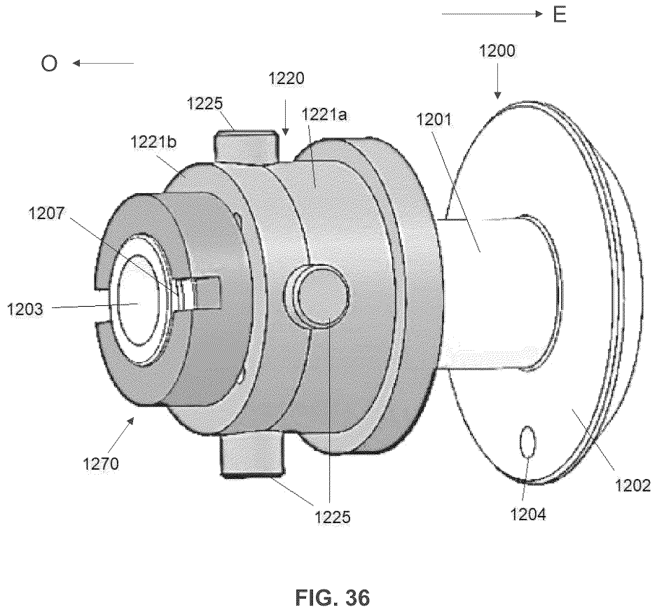

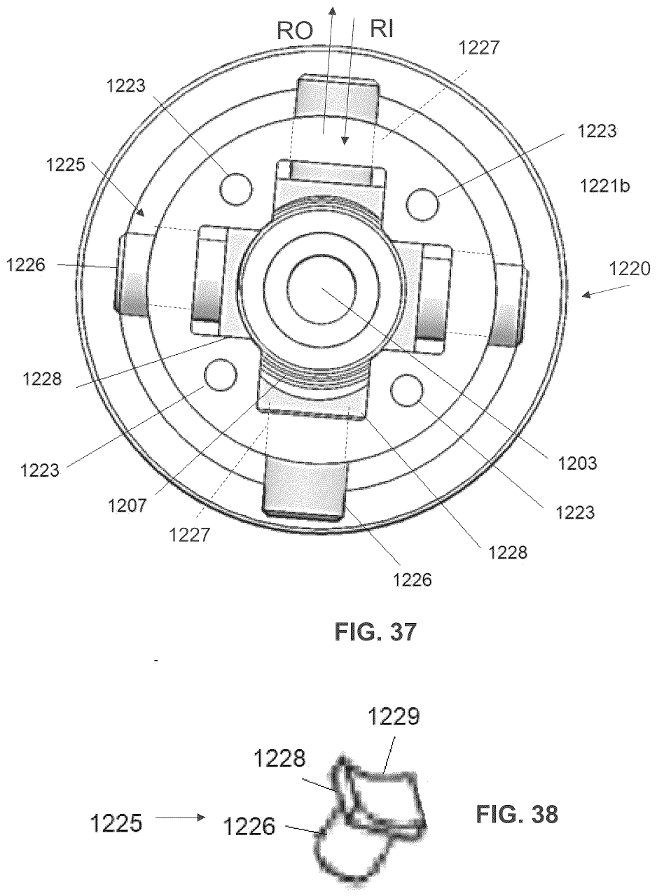

As illustrated in FIG. 33, a bushing 1220 is coupled to the right front bridge 1172 of the right barrel 1110. FIGS. 36-37 illustrate the bushing 1220 in greater detail. The bushing 1220 is arranged such that the bore 1221 of the bushing 1220 is aligned with the aperture 1175 in the right front bridge 1172. One or more screws 1230 secure the bushing 1220 to the right front bridge 1172 by passing through holes 1223 in bushing 1220 and into threaded holes 1176 in right front bridge 1172. It is understood that bushing 1220 can be secured to right front bridge 1172 by other means known in the art, such as adhesives.

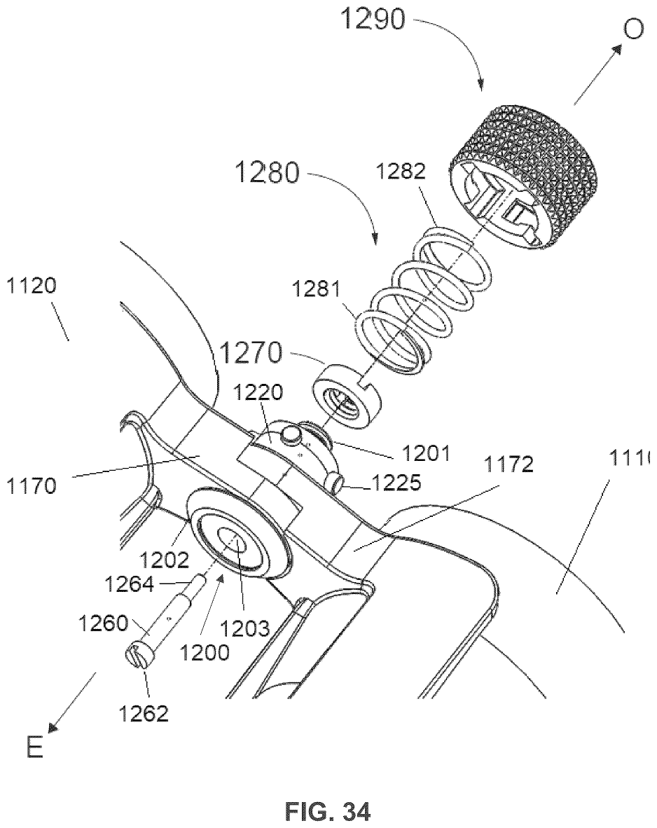

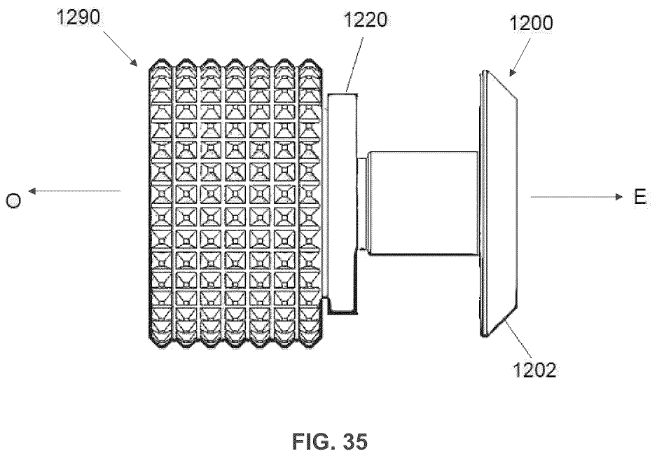

FIG. 34 illustrates the assembly of components shown in FIGS. 32-33. In particular, the shaft portion 1201 of shaft member 1200 passes through the apertures 1175 of right front bridge 1172 and the bore 1221 of bushing 1220. A nut 1270 is threadedly secured to a threaded end potion 1207 of shaft member 1200. The left barrel 1120 and right barrel 1110 are capable of freely pivoting about shaft member 1200 to adjust the IPD of the eyepieces 130 With continued reference to FIG. 34, a longitudinal member, e.g., slider screw 1260, is slidably inserted within the bore 1203 of the pivoting member, e.g., shaft member 1200. The limit of longitudinal travel of the slider screw 1260 is established by the contact of the head 1262 thereof with a shoulder (not shown) defined within the bore 1203 of the shaft member 1200. (See also FIGS. 9-10, which describes in greater detail for similar configuration of slider screw 260 and split screw 200.) A biasing member, such as coil spring 1280, is positioned about nut 1270 with one end 1281 in contact with bushing 1220. Cap 1290 is threadingly coupled to a complementary threaded end portion 1264 of slider screw 1260. When the slider screw 1260 is coupled to the cap 1290, the slider screw 1260 and the cap 1290 are capable of sliding longitudinally together. The spring 1280 includes a second end 1282 in contact with the inner surface 1308 of cap 1290, biasing the cap 1290 apart from the bushing 1220.

FIGS. 35-37 illustrate further details of the IPD locking mechanism of binoculars 1000. FIG. 35 illustrates the shaft member 1200, bushing 1220 and cap 1290. For illustrative purposes, the bridges portions 1170 and 1172 are not shown. In FIG. 36, the cap 1290 is removed for illustrative purposes. In some embodiments, the bushing 1220 includes two components 1221a/1221b. The pads 1125 are radially slidably within radial bores 1227 (shown as dashed lines in FIG. 37) in the bushing 1220. The bushing components 1221a/1221b and pads 1225 are secured together as an assembly to bridge portion 1172 via screws 1230 as shown in FIG. 33. As shown in FIG. 35, nut 1270 is secured to threaded end 1207 of shaft 1201.

FIG. 37 shows an objective end view of bushing 1220 and pads 1225 with the nut 1270 removed for illustrative purposes. The pads 1225 are radially slidable (radially outwardly direction shown by arrow RO and radially inwardly direction shown by arrow RI) within bushing 1220. When pads 1225 are advanced radially inward RI, the pads 1225 frictionally engage the shaft member 1200 to prevent rotation of bridge member 1170 with respect to bridge member 1172, thereby locking the binoculars 1000 with respect to IPD. As shown in FIG. 38, each of the pads 1225 includes a cylindrical rod portion 1226 and an engagement portion 1228 having an arcuate engagement surface 1229. The rod portion 1226 is slidable within the radial bores 1227 of the bushing 1220. The engagement surface 1229 has an arcuate curvature to conform to the outer surface 1205 of the shaft portion 1201. In some embodiments, the pad 1225, including the rod portion 1226 and the engagement portion 1228, is fabricated from metal, e.g., steel. The arcuate engagement surface 1229 is coated with a softer material, e.g., rubber or a polymer coating, in order to grip the outer surface 1205 of the shaft portion 1201 of the shaft member 1200.

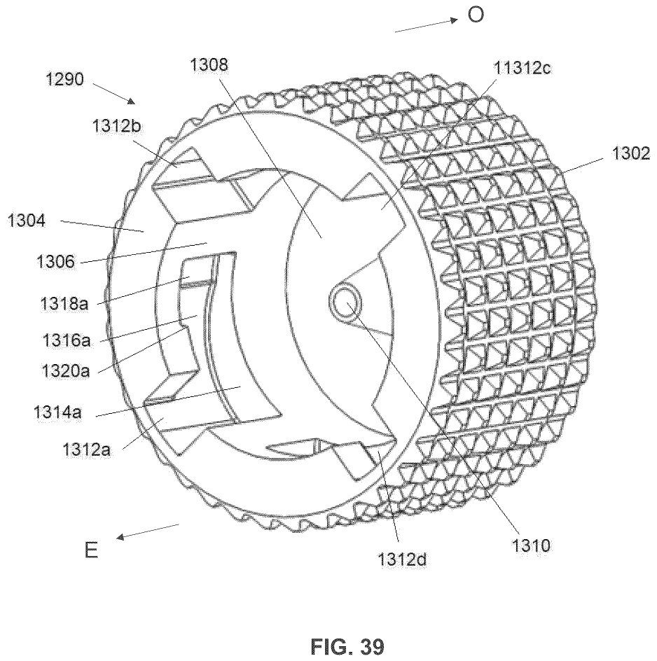

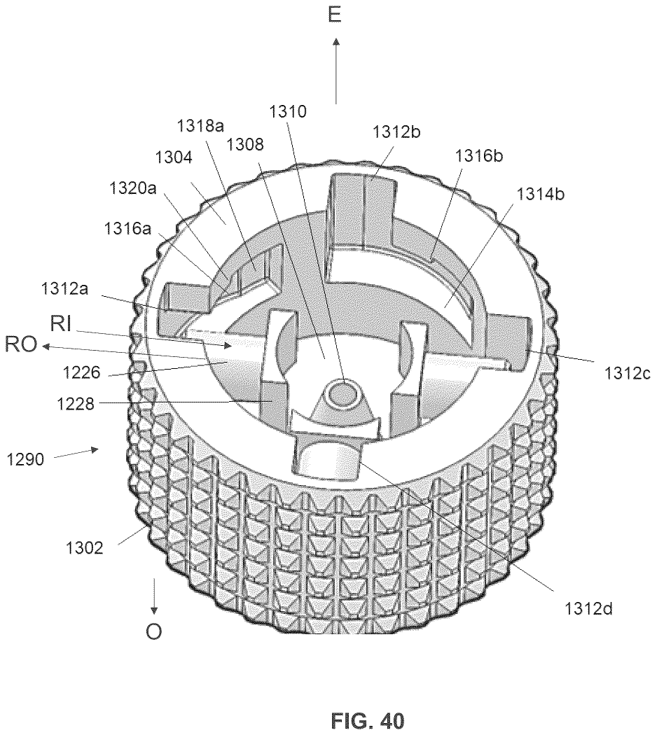

The cap 1290 is illustrated in greater detail in FIGS. 39-40. The cap 1290 is secured to the threaded end portion 1264 of the slider screw 1260. Cap 1290 includes an outer texture or knurling 1302 to improve grip on the cap 1290 by the user. A projection 1310 extends longitudinally outwardly from the inner surface 1308 of the screw 1290 and includes a threaded bore receiving the threaded end portion 1264 of the slider screw 1260. The second end 1282 of the spring 1280 engages the inner surface 1308 of the cap 1290 and biases the cap 1290 apart from the bushing 1220. The outer surface 1304 of the cap 1290 includes a plurality of recesses 1312a, 1312b, 1312c, 1312d for receiving the rod portions 1226 of the pads 1225.

Each of the recesses 1312a, 1312b, 1312c, 1312d extends into limiting surface 1314a, 1314b, 1314c, 1314d, that limits the longitudinal travel of the cap 1290 towards the bushing 1220. Recesses 1312a, 1312b, 1312c, 1312d extend into angular sloped cam surfaces 1316a, 1316b, 1316c, 1316d. At the end of the angular extent of the slope cam surfaces 1316a, 1316b, 1316c, 1316d is a flat portion 1318a, 1318b, 1318c, 1318d. A shoulder portion 1320a, 1320b, 1320c, 1320d is provided adjacent the flat portion 1318a, 1318b, 1318c, 1318d. (FIG. 39 illustrates components 1314a, 1316a, 1318a, and 1320a corresponding to recess 1312a. It is understood that the components corresponding to 1312b, 1312c and 1312d are identical, although not illustrated in FIG. 39.) In order to apply the IPD locking mechanism to lock the binoculars 1000, the cap 1290 is moved in the eyepiece E direction and approximated with the bushing 1220 against the bias of spring 1280. In some embodiments, the cap 1290 is fabricated from metal, e.g., steel. As the cap 1290 is moved towards the bushing 1220, the rod portions 1226 of each of the pads 1225 is received into the corresponding recesses 1312a, 1312b, 1312c, 1312d of the cap 1290 until the pads 1225 engage the limiting surfaces 1314a, 1314b, 1314c, 1314d. At such point, the user rotates the cap 1290, such that each of the rod portions 1226 is urged radially inward (arrow RI of FIG. 40) by the respective sloped cam surfaces 1316a, 1316b, 1316c, 1316d. Upon further rotation, each of the rod portions 1226 is received in respective flat portion 1318a, 1318b, 1318c, 1318d. In this configuration, the arcuate engagement surfaces 1229 of the pads 1225 are in firm, frictional engagement with the outer surface 1205 of the shaft portion 1201, such that the pads 1225 are immobile relative to the shaft member 1200, thereby placing the binoculars 1000 in a locked configuration. When locked, the left front bridge 1170 and right front bridge 1172 are immovable relative to each other, thereby locking the left barrel 1120 and right barrel 1110, and also the eyepieces 1130 to a fixed IPD.

In the unlocked configuration, the left front bridge 1170 and right front bridge 1172 are pivotable relative to each other, thereby allowing the left barrel 1120 and right barrel 1110 and the eyepieces 1130 to adjust the IPD. In order to unlock the binoculars 1000, the locking procedure described herein is essentially reversed. The cap 1290 is rotated in the opposite direction, such that the rod portions 1226 of the pads 1225 are moved from the respective flat portions 1318a, 1318b, 1318c, 1318d to the respective sloped cam surfaces 1316a, 1316b, 1316c, 1316d. Accordingly, the rod portions 1226 move radially outward (arrow RO in FIG. 40), thereby releasing contact of the arcuate engagement surfaces 1229 from engagement with the outer surface 1205 of the shaft portion 1201. As the cap 1290 is rotated, additional, optional force is applied to pads 1225 to move them radially outward RO. In some embodiments, a coil spring is positioned about the rod portion 1226 to bias the pad 1225 radially outwardly as the cap 1290 is rotated. In some embodiments, one or more magnetic attractors are applied to the cap 1290 and/or the pads 1225 to move the pad 1225 radially outwardly as the cap 1290 is rotated. In some embodiments, mechanical linkage between the recesses 1312a, 1312b, 1312c, 1312d and the sloped cam surfaces 1316a, 1316b, 1316c, 1316d to move the pad 1225 radially outwardly as the cap 1290 is rotated, e.g., by providing an increasing diameter on the rod portion 1226 within the cap.

In an exemplary embodiment, a pair of binoculars is provided, including a first barrel having a first eyepiece optic, a first objective optic and a first bridge portion, the first barrel defining a first longitudinal axis extending from the first eyepiece optic to the first objective optic; a second barrel having a second eyepiece optic, a second objective optic and a second bridge portion, the second barrel defining a second longitudinal axis substantially parallel to the first longitudinal axis extending from the second eyepiece optic to the second objective optic; wherein the first bridge portion and the second bridge portion are angularly pivotable about a third longitudinal axis substantially parallel to the first and second longitudinal axis and capable to adjusting an interpupillary distance (IPD) between the first eyepiece optic and the second eyepiece optic; and a locking assembly. The locking assembly includes a pivoting member fixed to the first bridge portion; a bushing fixed to the second bridge portion and including one or more moveable pads, each defining an engagement surface for contacting the pivoting member; and a rotatable cap defining a sloped cam surface for engaging the one or more pads. When the cap is rotated in a first direction, the sloped cam surface advances the one or more pads into frictional engagement with the pivoting member such that the first bridge portion is immobile relative to the second bridge portion, and when the cap is rotated in a second direction, the internal sloped cam surface allow the one or more pads to be spaced apart from the pivoting member such that the first bridge portion is moveable relative to the second bridge portion.

With reference to the drawings, this section describes particular embodiments and their detailed construction and operation. The embodiments described herein are set forth by way of illustration only and not limitation. The described features, structures, characteristics, and methods of operation may be combined in any suitable manner in one or more embodiments. In view of the disclosure herein, those skilled in the art will recognize that the various embodiments can be practiced without one or more of the specific details or with other methods, components, materials, or the like. In other instances, well-known structures, materials, or methods of operation are not shown or not described in detail to avoid obscuring more pertinent aspects of the embodiments.

What is claimed is:

1. A pair of binoculars comprising:
a first barrel comprising a first eyepiece optic, a first objective optic and a first bridge portion, the first barrel defining a first longitudinal axis extending from the first eyepiece optic to the first objective optic;
a second barrel comprising a second eyepiece optic, a second objective optic and a second bridge portion, the second barrel defining a second longitudinal axis substantially parallel to the first longitudinal axis extending from the second eyepiece optic to the second objective optic; wherein the first bridge portion and the second bridge portion are angularly pivotable about a third longitudinal axis substantially parallel to the first and second longitudinal axis and capable to adjusting an interpupillary distance (IPD) between the first eyepiece optic and the second eyepiece optic; and
a locking assembly comprising;
a pivoting member fixed to the first bridge portion;
a bushing fixed to the second bridge portion and defining a first engagement surface; and
a locking member restricting relative angular movement between the locking member, the pivoting member and the first bridge portion, the locking member defining a second engagement surface and longitudinally movable along the third longitudinal axis between at least a first position spaced apart from the first engagement surface and a second position engaged with the first engagement surface, such that when the first engagement surface and the second engagement surface are engaged, the first bridge portion is immobile relative to the second bridge portion.

2. The pair of binoculars of claim 1, wherein the first engagement surface comprises gear teeth, and the second engagement surface comprises gear teeth.

3. The part of binoculars of claim 1, wherein the first engagement surface and the second engagement surface comprise mating tapered surfaces.

4. The pair of binoculars of claim 1, wherein the pivoting member defines a longitudinal bore therethrough, and the locking member comprises a longitudinal member longitudinally slidable within the longitudinal bore.

5. The pair of binoculars of claim 4, wherein the longitudinal bore of the pivoting member defines a shoulder portion engageable with a head portion of the longitudinal member to restrict the longitudinal movement of the longitudinal member with respect to the pivoting member.

6. The pair of binoculars of claim 1, wherein the locking member further comprises a disc coupled to the longitudinal member and defining a projection having a pair of surfaces.

7. The pair of binoculars of claim 5, wherein the pivoting member is a split screw comprising a first member and a second member spaced apart from the first member, and wherein the pair of surfaces of the projection cooperate with the first and second members to restrict relative angular movement between the locking member, the pivoting member and the first bridge portion.

8. The pair of binoculars of claim 5, wherein the locking member comprising an annular ring, and wherein the second engagement surface comprises gear teeth on the ring, and the first engagement surface comprises gear teeth on the bushing.

9. The pair of binoculars of claim 7, wherein the bushing supports an O-ring thereon, and the annular ring defines a first and a second annular recess for cooperating with the O-ring when the locking member is in the first and second positions.

10. The pair of binoculars of claim 1, wherein the annular ring comprises external textured surface.

11. A pair of binoculars comprising:
a first barrel comprising a first eyepiece optic, a first objective optic and a first contact surface, the first barrel defining a first longitudinal axis extending from the first eyepiece optic to the first objective optic;
a second barrel comprising a second eyepiece optic, a second objective optic and a second contact surface, the second barrel defining a second longitudinal axis substantially parallel to the first longitudinal axis extending from the second eyepiece optic to the second objective optic; wherein the first bridge portion and the second bridge portion are angularly pivotable about a third longitudinal axis substantially parallel to the first and second longitudinal axis and capable to adjusting an interpupillary distance (IPD) between the first eyepiece optic and the second eyepiece optic; and
a locking assembly comprising;
an adjustable member defining a surface movable between a first position spaced apart from the first contact surface and the second contact surface, and a second position engaged with the first contact surface and the second contact surface to prevent relative pivotable movement of the first barrel with respect to the second barrel.

12. The pair of binoculars of claim 11, wherein the adjustable member comprising a flexible sleeve, and the locking assembly further comprises a first disc and second disc, and wherein the first contact surface is disposed on a first bridge portion of the first barrel and the second contact surface is disposed on a second bridge of the second barrel,
wherein, when the first disc and second disc are approximated the flexible sleeve expands to the second position to contact the first and second contact surfaces, and when the first and second disc are spaced apart, the flexible sleeve is in a relaxed configuration spaced apart from the first and second contact surfaces 13. The pair of binoculars of claim 11, wherein the adjustable member comprising a push button have a pair of first splines, and the first and second contact surfaces comprise second splines disposed on the first barrel and the second barrel,
wherein the first configuration comprises the first splines on the push button and the second splines on the first and second barrel are spaced apart, and the second configuration comprises the first splines on the push button and the second splines on the first and second barrel are approximated.

14. The pair of binoculars of claim 11, wherein the adjustable member comprising a longitudinally movable wedge member, and the first and second contact surfaces comprise angled side walls disposed on the first barrel and the second barrel,
wherein the first configuration comprises the wedge member longitudinally spaced apart from the angled side walls, and the second configuration comprises the wedge member longitudinally positioned to engage the angled side walls.

15. The pair of binoculars of claim 11, wherein the adjustable member comprising an angular rotatable member comprising a pivotable lever defining a cam surface, and wherein the first contact surface is disposed on a first bridge portion of the first barrel and the second contact surface is disposed on a second bridge of the second barrel,
wherein when the pivotable lever is in a first position, the cam surface is spaced apart from the first and second engagement surfaces, and then the lever is in the second position, the cam surface is engaged with first and second contact surfaces.

16. The pair of binoculars of claim 11, wherein the first contact surface is disposed on a first bridge portion of the first barrel and the second contact surface is disposed on a second bridge of the second barrel, and wherein the adjustable member comprises:
a stem fixed to one of the first and second bridge portions, the stem defining a helical cam surface;
a body defining a body contact surface and a angularly disposed slot; and
a lever and sleeve angularly disposed about the stem and within the angular disposed body, such that lever moves longitudinally with the body, and an end portion of the lever disposed within the helical cam, such that when the lever is angularly rotated with respect to the stem, the lever is disposed longitudinally, the first configuration comprising when the body contact surface is spaced apparat from the first and second contact surfaces and the second configuration comprising the body contact surface spaced apart from the first and second contact surfaces.
